(19) United States
(12) Patent Application Publication
(10) Pub. No.: US 2022/0326595 A1
(43) Pub. Date: Oct. 13, 2022

(54) WRITABLE SCREEN

(71) Applicant: GOYO PAPER WORKING CO., LTD., Osaka-shi, Osaka (JP)

(72) Inventors: Kyohei NOMURA, Osaka-shi, Osaka (JP); Noriaki OKUNAKA, Osaka-shi, Osaka (JP)

(21) Appl. No.: 17/623,663

(22) PCT Filed: Jul. 16, 2020
(86) PCT No.: PCT/JP2020/027745

§ 371 Date: Jun. 7, 2022

(30) Foreign Application Priority Data
Aug. 27, 2019 (JP) 2019-154408

(51) Int. Cl. G03B 21/60; B43L 1/00

(52) U.S. Cl. CPC G03B 21/60; B43L 1/00

(57) ABSTRACT

The writable screen of the present invention includes a base layer and a resin layer provided on the base layer. The resin layer has a surface gloss of 1% to 20% and a surface pencil hardness of 5H to 2B. The present invention can improve the erasability with a whiteboard eraser for writing made with a whiteboard marker and also can prevent or reduce the occurrence of a hot spot and glare.

### TECHNICAL FIELD

The present invention relates to a writable screen, and more particularly, to a writable screen with improved properties of displaying images projected thereon.

### BACKGROUND ART

In recent years, screens are known that have a function as a projection screen, namely, a function of displaying characters, photographs, graphics, and the like output from a projector connected to an information or telecommunication device such as a personal computer, a tablet terminal, or a smartphone, and that are also writable with a whiteboard marker or the like and erasable with a whiteboard eraser. Such screens are called “projection screens” or “writable screens”.

In conventional projection screens, attempts have been made to suppress glare called a “hot spot” and to expand the image viewing angle by causing diffuse reflection of projected light from a projector. To this end, irregularities are formed on the screen surface by, for example, embossing the surface material or kneading fine particles into the surface material.

However, a satisfactory writable screen that causes no hot spot or glare in use and attains a good balance among the writability, erasability, scratch resistance in long-term use, and the like has not yet been developed.

For example, Patent Document 1 proposes a screen produced by applying an ultraviolet curable resin to a surface of a polyethylene terephthalate resin film, curing the ultraviolet curable resin, and then embossing a surface of the thus-obtained cured coating to form irregularities thereon, thereby providing a screen surface having an arithmetic mean roughness of about 1.5 to 3.0 μm with a mean spacing between adjacent peaks being about 50 to 280 μm. The screen disclosed in Patent Document 1 aims to improve the erasability for characters and the like written with a whiteboard marker.

Patent Document 2 discloses a writable screen in which a resin layer containing fine particles is provided on a base, an arithmetic average roughness Ra1 of a writing and projection surface (as determined in a manner that complies with JIS B0601 (2001) with the cutoff value being 0.8 mm and the stylus tip radius being 2.5 μm) is 0.1 to 3.0 μm, and an arithmetic average roughness Ra2 of the writing and projection surface (as determined in a manner that complies with JIS B0601 (2001) with the cutoff value being 0.08 mm and the stylus tip radius being 2.5 μm) is 0.05 to 0.20 μm. The screen disclosed in Patent Document 2 aims to improve the writability and the erasability and also to alleviate the occurrence of a hot spot and glare.

Patent Document 3 discloses a projection screen produced by applying an ultraviolet curable resin that contains fine particles having an average particle size of 2 to 12 μm on a thermoplastic resin base and then curing the ultraviolet curable resin. Patent Document 3 also describes that, by adding a fluorine compound or a silicone compound to the ultraviolet curable resin, the cured surface has a gloss (60-degree surface gloss) of about 3 to 38, whereby the occurrence of a hot spot is alleviated and the erasability is improved.

The screens disclosed in Patent Documents 1 to 3 can be expected to bring about the effects of making improvements intended by the respective patent documents. However, it is still unreasonable to say that these screens can achieve a well-balanced improvement in the writing function relating to the writability and the erasability at the time of using a whiteboard marker and a whiteboard eraser and the projection function relating to the prevention or reduction of the occurrence of a hot spot and glare. Accordingly, there is a demand for further development of writable screens.

### RELATED ART DOCUMENTS

### Patent Documents

[Patent Document 1] WO 2001/032440
[Patent Document 2] WO 2013/137099
[Patent Document 3] Japanese Patent Laid-Open No. 2018-54809

### SUMMARY OF THE INVENTION

### Problems to be Solved by the Invention

The present invention aims to solve the above-described problems, and it is an object of the present invention to provide a writable screen capable of achieving a well-balanced improvement in the writing function relating to the writability and the erasability at the time of using a whiteboard marker and a whiteboard eraser and the projection function relating to the prevention or reduction of the occurrence of a hot spot and glare.

### Means for Solving the Problem

The present invention is a writable screen comprising a base layer and a resin layer provided on the base layer, wherein the resin layer has a surface gloss of 1% to 20% and a surface pencil hardness of 5H to 2B.

In one embodiment, the surface gloss of the resin layer is 5% to 14%.

In one embodiment, the surface pencil hardness of the resin layer is 2H to B.

In one embodiment, the resin layer is composed of a cured product of an ultraviolet curable resin with a reactive silicone.

In a further embodiment, the reactive silicone is a polysiloxane modified with an acrylic acid group or a methacrylic acid group.

### Effects of the Invention

The present invention can improve the erasability with a whiteboard eraser for writing made with a whiteboard marker and also can prevent or reduce the occurrence of a hot spot and glare.

### BRIEF DESCRIPTION OF DRAWINGS

FIG. 1 is a schematic cross-sectional view showing an example of the writable screen of the present invention.

### DESCRIPTION OF EMBODIMENTS

The present invention will be described in detail below.

The writable screen of the present invention includes a resin layer provided on a base layer.

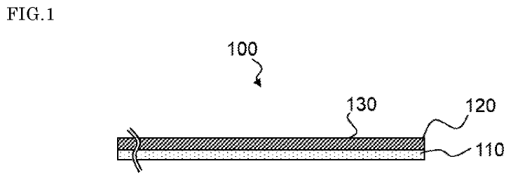

FIG. 1 is a schematic cross-sectional view showing an example of the writable screen of the present invention. FIG. 1 shows a screen 100 in which a resin layer 120 is disposed on one surface of a base layer 110. Although the resin layer 120 is disposed in direct contact with the base layer 110 in FIG. 1, the present invention is not limited to such an embodiment. For example, a primer layer or a pressure-sensitive adhesive layer formed using a material to be described below may be provided between the resin layer 120 and the base layer 110.

The material of the base layer may be, for example, paper (e.g., paperboard, Western paper, or Japanese paper), synthetic paper, fabric (e.g., woven fabric, knitted fabric, or non-woven fabric), a sheet or film made of a synthetic resin, or a laminate thereof. Considering the fact that the base layer is a component of the screen, at least one surface of the base layer (in FIG. 1, of the surfaces of the base layer 110, the surface on the side on which the resin layer 120 is disposed) is preferably white.

In the present invention, of the above-described examples of the material of the base layer, a sheet or film made of a synthetic resin is preferable because of its favorable durability, flatness, and the like. The sheet or film made of a synthetic resin is preferably a white polyester resin sheet or film and more preferably a biaxially-stretched white polyester film, because of its favorable strength, dimensional stability, heat resistance, and the like. Examples of such a biaxially-stretched white polyester film include commercially available products such as DIAFOIL W400J manufactured by Mitsubishi Chemical Corporation, LUMIRROR E28G manufactured by Toray Industries, Inc., a TEIJIN® TETORON® film U292W manufactured by Teijin Film Solutions Limited, and Crisper K2323 manufactured by Toyobo Co., Ltd.

The thickness of the base layer in the writable screen of the present invention is not necessarily limited, and is, for example, 25 μm to 250 μm and more preferably 75 μm to 200 μm. The base layer with a thickness of less than 25 μm cannot impart sufficient strength to the resulting screen, and this may cause the screen to be likely to be damaged during use (for example, at the time of erasing characters with a board eraser). On the other hand, if the thickness of the base layer is increased to more than 250 μm, it does not make any further contribution to the desired improvement in the writing function and the projection function, but rather merely increases the self-weight of the resulting screen itself.

In the present invention, the resin layer has a predetermined surface gloss and a predetermined surface pencil hardness.

The surface gloss of the resin layer is, for example, the gloss of an outer surface 130 of the resin layer 120 of the writable screen 100 shown in FIG. 1. Such a surface gloss is also called a “gloss” (60-degree specular gloss) and is measured in compliance with JIS Z 8741 (1997).

The surface gloss of the resin layer included in the writable screen of the present invention is 1% to 20% and preferably 5% to 14%. When the surface gloss of the resin layer is less than 1%, a whiteboard marker and a whiteboard eraser move less smoothly on the outer surface of the resin layer and the sharpness of projected images may be reduced. When the surface gloss of the resin layer is more than 20%, the whole resin layer becomes highly glossy, and glare may be perceived using the resultant screen. The surface gloss of such a resin layer can be adjusted by adjusting, for example, the following conditions that can be employed when producing the writable screen of the present invention: the surface roughness of a pinch roll or a press roll in a machine, the surface roughness of a textured sheet, the type or curing conditions of an ultraviolet curable resin, or the type or an amount of a curing agent.

The surface pencil hardness of the resin layer is, for example, the hardness of the outer surface 130 of the resin layer 120 of the writable screen 100 shown in FIG. 1. The surface pencil hardness is measured in the following manner.

First, hardness testing pencils (a group of 14 pencils with different hardnesses ranging from 6B to 6H) are prepared, and only their wood casings are partially removed by shaving, thereby exposing 5 to 6 mm of their leads. The pencil with a hardness of 6B, which is the softest one in the group of pencils, is first set in a pencil hardness tester. The pencil is held at an angle of 45±1° with a load of 750±10 g being applied to the tip of the lead, and is moved at least 7 mm at a speed of 0.5 to 1 mm/second on the outer surface of the resin layer of the screen. Subsequently, the surface of the resin layer on which the lead of the pencil has been moved is wiped using either a soft cloth or absorbent cotton with an inert solvent, and then, the outer surface of the resin layer is visually inspected for a scratch. Thereafter, the same operation and visual inspection as those described above are performed using, of the above-described group of 14 pencils, the one whose hardness is next higher than 6B. Such an operation and visual inspection are carried on (for harder and harder pencils until the 6H pencil is finally used) to find a scratch on the outer surface of the resin layer.

When a scratch is observed on the outer surface of the resin layer, the pencil hardness (any of 6B to 6H) that is next lower than the hardness of the pencil used in the operation that caused the scratch is indicated as the surface pencil hardness of the resin layer.

The surface pencil hardness of the resin layer included in the writable screen of the present invention is 5H to 2B and preferably 2H to B, according to the seventeen grades of hardness from 9E1 to 6B specified in JIS (JIS K 5600-5-4). When the surface pencil hardness of the resin layer is higher than 5H (i.e., when the surface pencil hardness is 6H or is unmeasurable because the outer surface of the resin layer is too hard), the resin layer may crack when the screen is bent or wound. This may deteriorate the surface quality, resulting in reduced erasability. When the surface pencil hardness of the resin layer is lower than 2B (i.e., when the surface pencil hardness is any of 3B to 6B or is unmeasurable because the outer surface of the resin layer is too soft), the outer surface of the resin layer is likely to have scratches caused by a whiteboard eraser, resulting in poor scratch resistance. Accordingly, scratches caused by long-term use may deteriorate the surface, resulting in reduced erasability for a whiteboard marker. Such a surface pencil strength of the resin layer can be adjusted by adjusting, for example, the following conditions that can be employed when producing the writable screen of the present invention: the type or curing conditions of an ultraviolet curable resin or the type or amount of a curing agent. For example, the surface pencil hardness can be increased by increasing the degree of cure of the resin layer.

In the present invention, the resin layer is composed of a cured product of a resin composition for producing a writable screen.

This writable screen resin composition contains, for example, an ultraviolet curable resin or a mixture of an ultraviolet curable resin and a reactive silicone.

Ultraviolet curable resins are monomers and oligomers having properties of causing a polymerization reaction to solidify when irradiated with light (in particular, ultraviolet rays), and examples thereof include those having properties of causing radical polymerization of unsaturated double bonds when irradiated with light (acrylate-type ultraviolet curable resins) and those having properties of causing cationic polymerization when irradiated with light (epoxy-type ultraviolet curable resins). Specific examples of such ultraviolet curable resins include epoxy-modified acrylate resins, urethane-modified acrylate resins, silicone-modified acrylate resins, and epoxy resins, as well as their fluorine-modified oligomers or monomers, and resins containing a known photopolymerization initiator.

Examples of the ultraviolet curable resin include: SEIKABEAM NR-G4 manufactured by Dainichiseika Color & Chemicals Mfg. Co., Ltd.; GY-2 manufactured by Kyoeisha Chemical Co., Ltd.; and GYO-111A, DPR-047, and PET-061 manufactured by Nippon Kayaku Co., Ltd; and SHIKOH® UV-7510B manufactured by The Nippon Synthetic Chemical Industry Co., Ltd.

A reactive silicone is a silicone oil in which a reactive functional group has been introduced into some of silicon atoms constituting the silicone. By using the reactive silicone in combination with the ultraviolet curable resin, the characteristics of the silicone oil can also be imparted by the reactive silicone when the resin is cured by ultraviolet irradiation. A reactive silicone is also called a “solventless reactive silicone”. Examples of such a reactive silicone include those having a reactive functional group added to one end of a molecule constituting a polysiloxane (single-end-type reactive silicones) and those having a reactive functional group added to a side chain of a molecule constituting a polysiloxane (side-chain-type reactive silicones), as well as combinations thereof. A single-end-type reactive silicone can be graft copolymerized with, for example, a resin (ultraviolet curable resin), and can impart water repellency and slipperiness to a resin surface. A side-chain-type reactive silicone can be randomly copolymerized with, for example, a resin (ultraviolet curable resin), and can impart water repellency and slipperiness to a resin surface.

Examples of the reactive functional group in the single-end-type reactive silicone and/or the side-chain-type reactive silicone include an amino group, a diamino group, an epoxy group, an alicyclic epoxy group, a carbinol group, a mercapto group, a carboxyl group, a diol group, an acrylic group, and a methacrylic group, as well as combinations thereof. From the viewpoint of capability of imparting a favorable writing function (e.g., writability and erasability with a whiteboard marker or a whiteboard eraser) to the resulting screen, the reactive silicone is preferably a polysiloxane modified with an acrylic acid group or a methacrylic acid group and more preferably a single-end-type reactive polysiloxane (single-end-type reactive silicone) in which one end of a molecule of the polysiloxane is modified with an acrylic acid group or a methacrylic acid group.

Examples of the reactive silicone include “Shin-Etsu Silicone Oil X-22-174” series commercially available from Shin-Etsu Chemical Co., Ltd. Of these, Shin-Etsu Silicone Oil X-22-174AS-X is particularly preferable.

The content of the reactive silicone in the writable screen resin composition is 0.5 to 10 parts by weight and preferably 1 to 8 parts by weight with respect to 100 parts by weight of the ultraviolet curable resin. When the content of the reactive silicone is less than 0.5 parts by weight, the erasability with a whiteboard eraser and/or the slipperiness of the resulting screen may be reduced. When the content of the reactive silicone is more than 10 parts by weight, the reactive silicone exhibits reduced dispersibility when mixed with the ultraviolet curable resin, whereby it may be difficult to obtain a homogeneous resin composition.

The writable screen resin composition may contain fine particles in order to further improve both the writing function and the projection function of the resulting screen. Examples of such fine particles include those made of organic materials (e.g., thermoplastic resins such as polyethylene, polypropylene, and acrylic resins) and those made of inorganic materials (e.g., glass, silica, alumina, titanium compounds, and zirconium compounds), as well as combinations thereof. The average particle size and the content of the fine particles are not limited to particular values, and an appropriate average particle size and an appropriate content can be selected by those skilled in the art.

The writable screen resin composition may further contain one or more other additives, when necessary. Examples of such other additives include an antioxidant (e.g., a phenolic antioxidant, a sulfur-based antioxidant, and/or a phosphorus-based antioxidants); an antistatic agent (e.g., an anionic surfactant, a cationic surfactant, a nonionic surfactant, and/or an amphoteric surfactant); a lubricant (e.g., a hydrocarbon-based lubricant, a fatty acid-based lubricant, a higher alcohol-based lubricant, a fatty acid amide-based lubricant, a metallic soap-based lubricant, and/or an ester-based lubricant); and a flame retardant (e.g., an organic flame retardant and/or an inorganic flame retardant); as well as combinations thereof. The content of the above-described additives that the writable screen resin composition may contain is not limited to particular values, and an appropriate amount can be selected by those skilled in the art.

The thickness of the resin layer in the writable screen of the present invention is not necessarily limited, and is, for example, 2 μm to 50 μm and more preferably 5 μm to 20 μm. When the thickness of the resin layer is less than 2 μm, maintaining the uniformity in coating (i.e., disposing the resin layer having a substantially uniform thickness on the base layer) may be difficult. When the thickness of the resin layer is more than 50 μm, the resulting screen may curl.

When the writable screen of the present invention includes a primer layer disposed between the base layer and the resin layer, the material of the primer layer is not limited to particular materials, and known materials in the art may be employed. Also, the thickness of the primer layer is not limited to particular values, and an appropriate thickness can be selected by those skilled in the art.

In the writable screen of the present invention, another layer such as a magnet sheet may be provided, for example, via a pressure-sensitive adhesive layer or an adhesive layer on the other surface of the base layer, i.e., the surface on the side opposite to the surface to be in contact with the resin layer. When the writable screen of the present invention is provided with the magnetic sheet, the writable screen of the present invention can be easily set on a predetermined location such as a blackboard or a metal partition and also can be easily detached therefrom. Such a magnet sheet is commercially available.

The writable screen of present invention can be produced in the following manner, for example.

First, the above-described writable screen resin composition is disposed on the base layer.

Specifically, the writable screen resin composition that contains either the ultraviolet curable resin or a mixture of the ultraviolet curable resin and the reactive silicone is provided on one surface of the material constituting the base layer in the form of, for example, a uniform mixture. The writable screen resin composition is provided on the base layer by, for example, applying or spraying the writable screen resin composition using a means known in the art.

After the writable screen resin composition is disposed on the base layer, the surface provided with the writable screen resin composition may be subjected to surface embossing so as to allow the surface to have predetermined irregularities or physical shapes for causing diffuse reflection of projected light emitted from a projector on the surface of the resulting screen in order to prevent the occurrence of a hot spot. This surface embossing can be performed using a means known in the art.

As a result, the writable screen resin composition is disposed on the base layer.

Subsequently, the resin composition disposed on the base layer is irradiated with ultraviolet rays.

Irradiation with ultraviolet rays is performed using a means known in the art, such as, for example, an ultraviolet irradiation device provided with an UV light source. Examples of the types of the UV light source that can be used include: lamps such as a mercury lamp, a metal halide lamp, a high-efficiency metal halide lamp, and a high-power metal halide lamp; and LED lights. In the present invention, ultraviolet rays used for irradiation preferably include those having a wavelength of 254 nm and/or those having a wavelength of 365 nm, and the irradiation time is not necessarily limited because it varies depending on the type and the output power of the UV light source to be used. The writable screen resin composition turns to a cured product on the base layer when irradiated with ultraviolet rays, thereby forming a resin layer.

The writable screen of the present invention is produced in the above-described manner.

In the writable screen of the present invention, the resin layer is freely writable with, for example, a commercially available whiteboard marker. Further, characters written and graphics drawn thereon can be easily erased using a commercially available whiteboard eraser. In addition, the writable screen of the present invention can allow light emitted from a projector to be projected on the resin layer while preventing or reducing the occurrence of a hot spot and glare. As described above, the writable screen of the present invention is excellent in both the writing function and the projection function, and these functions are improved in a well-balanced manner as compared with those in conventional screens.

The writable screen of the present invention is useful in, for example, various facilities such as offices, schools or educational facilities, libraries, hospitals, conference rooms for rent, exhibition halls, theaters, concert halls, commercial facilities, airports, and government offices.

### EXAMPLES

The present invention will be described in detail with reference to examples. It is to be noted, however, that the present invention is not limited to these examples by any means.

Evaluations of Screens

For screens produced or purchased in the following examples and comparative examples, evaluations were made on the following evaluation items.

(1) Surface Gloss

For each of the screens produced or purchased in the examples and comparative examples, the surface gloss (gloss, 60-degree specular gloss) on the outer surface was measured in a manner that complies with JIS Z 8741 (1997).

(2) Surface Pencil Hardness

First, hardness testing pencils (a group of 14 pencils with different hardnesses ranging from 6B to 6H) were prepared, and only their wood casings were partially removed by shaving, thereby exposing 5 to 6 mm of their leads. The pencil with a hardness of 6B, which is the softest one in the group of pencils, was first set in a pencil hardness tester. The pencil was held at an angle of 45±1° with a load of 750±10 g being applied to the tip of the lead, and was moved at least 7 mm at a speed of 0.5 to 1 mm/second on the outer surface of the resin layer of each of the screens produced or purchased in the examples and comparative examples. Subsequently, the surface of the resin layer on which the lead of the pencil had been moved was wiped using either a soft cloth or absorbent cotton with an inert solvent (propanol was used), and then, the outer surface of the resin layer was visually inspected for a scratch. Thereafter, the same operation and visual inspection as those described above were performed using, of the above-described group of 14 pencils, the one whose hardness is next higher than 6B. Such an operation and visual inspection were carried on (for harder and harder pencils until the 6H pencil is finally used) to find a scratch on the outer surface of the resin layer.

When a scratch was observed on the outer surface of the resin layer, the pencil hardness (any of 6B to 6H) that is next lower than the hardness of the pencil used in the operation that caused the scratch was determined as the surface pencil hardness of the resin layer.

(3) Hot Spot

The screen surface (the surface on the resin layer side) of each of the screens produced or purchased in the examples and comparative examples was irradiated with white light using a single-focus projector (VX425NXGA manufactured by Panasonic Corporation). Five panelists visually inspected the screen for the presence or absence of a hot spot, and thereafter, through consultation among all the panelists, the evaluation result was determined based on the following criteria:

“5”: A hot spot was not observed.
“4”: Although a slight hot spot was observed, it was at a negligible level.
“3”: Although a hot spot was observed, it was determined to be at a practically acceptable level.
“2”: A hot spot was observed, and it was determined to be at a practically unacceptable level.
“1”: An intense hot spot was observed and made the panelist uncomfortable.

(4) Glare

The screen surface (the surface on the resin layer side) of each of the screens produced or purchased in the examples and comparative examples was irradiated with white light using a single-focus projector (VX425NXGA manufactured by Panasonic Corporation). Five panelists visually inspected the screen for the presence or absence of glare, and thereafter, through consultation among all the panelists, the evaluation result was determined based on the following criteria:

“5”: Glare was not perceived at all.
“4”: Although slight glare was perceived, it was at a negligible level.
“3”: Although glare was perceived, it was at a practically acceptable level.
“2”: Glare was perceived, and it was at a practically unacceptable level.
“1”: Intense glare was perceived and made the panelist uncomfortable.

(5) Erasability

On the surface (the surface on the resin layer side) of each of the screens produced or purchased in the examples and comparative examples, five straight lines of about 10 cm in length were drawn using a commercially available whiteboard marker, and the screen was allowed to stand for 5 minutes in a room at a temperature of about 25° C. Then, these five straight lines were rubbed lightly and repeatedly with a commercially available whiteboard eraser, and five panelists each individually evaluated the ease of erasing the ink applied with the marker.

Thereafter, through consultation among all the panelists, the evaluation result was determined based on the following criteria:

“5”: Rubbing the ink 1 to 3 times without force could completely erase the ink.
“4”: Rubbing the ink 4 to 7 times without force could completely erase the ink.
“3”: Rubbing the ink 8 to 10 times without force could completely erase the ink.
“2”: Rubbing the ink 8 to 10 times without force could not completely erase the ink. Although the ink could be finally erased by rubbing the ink repeatedly with force, the screen was determined to be not practical enough.
“1”: Rubbing the ink repeatedly with force could not erase the ink, and the screen was determined to be impractical.

(6) Scratch Resistance

For each of the screens produced or purchased in the examples and comparative examples, a portion of the screen surface (the surface on the resin layer side) was rubbed back and forth 500 times with a commercially available whiteboard eraser. Then, a straight line of about 10 cm in length was drawn with a whiteboard marker on this rubbed portion, and the screen was allowed to stand for 5 minutes at a temperature of about 25° C. Then, five panelists examined through visual inspection whether this straight line could be erased cleanly with the whiteboard eraser and also the presence or absence of any scratch formed on the surface. Thereafter, through consultation among all the panelists, the evaluation result was determined based on the following criteria:

“5”: There was no scratch on the screen surface, and the straight line could be completely erased by rubbing the surface with the eraser 3 times or less.
“4”: There were a few scratches on the screen surface, and the straight line could be completely erased by rubbing the surface with the eraser 3 times or less.
“3”: There were a few scratches on the screen surface, and the straight line could be completely erased by rubbing the surface with the eraser 4 to 10 times.
“2”: Although the straight line could be completely erased by rubbing the surface with the eraser 4 to 10 times, prominent scratches were left on the screen surface, and the screen was determined to be not practical enough.
“1”: The screen was determined to be impractical for the following reason: prominent scratches were left on the screen surface and the straight line could not be erased by rubbing the screen surface with the eraser 10 times; or although there was no scratch on the screen surface, the straight line could not be erased by rubbing the surface with the eraser 10 times.

(7) Crack Resistance

Each of the screens produced or purchased in the examples and comparative examples was bent 180 degrees along the axis of a metal mandrel having a diameter of 10 mm, 8 mm, 6 mm, 4 mm, or 2 mm with the screen surface (the surface on the resin layer side) facing outward, and then returned to its original state. The screen surface was visually inspected for the presence or absence of cracks caused at this time, and the diameter of the mandrel used when the cracks occurred was recorded. The smaller the value of the recorded diameter, the higher the crack resistance. The screen that cracked in the operation using the mandrel having a diameter of 10 mm was determined to be impractical. The screens that did not crack in the operation using the mandrel having a diameter of 4 mm but cracked in the operation using the mandrel having a diameter of 2 mm and the screens that cracked even in the operation using the mandrel having a diameter of 2 mm were recorded as “2 mm or less”.

### Reference Example 1: Production of Embossed Sheets for Adjusting Surface Gloss

Seven chrome-plated iron rolls were surface-treated through sand-blasting to prepare eight types of pinch rolls having a embossed surface, whose surface gloss were 0.5%, 2%, 6%, 13%, 15%, 45%, and 60%, respectively. A polypropylene resin was extruded into sheet forms using these pinch rolls, thereby producing about 50 μm-thick embossed sheets for imparting surface gloss of 0.5%, 2%, 6%, 13%, 15%, 45%, and 60% to films obtained in the following examples and comparative examples. The surface gloss of screens (ES1) to (ES9) of Examples 1 to 9 and screens (CS4) to (CS7) of Comparative Examples 4 to 7 to be described below exactly correspond to the surface glosses of the embossed sheets used for these screens.

### Example 1

1 part by weight of a solventless reactive silicone (X-22-174AS-X manufactured by Shin-Etsu Chemical Co., Ltd.) was added to 100 parts by weight of an ultraviolet curable resin (SEIKABEAM NR-G4 manufactured by Dainichiseika Color & Chemicals Mfg. Co., Ltd.) to obtain a resin composition. Subsequently, this resin composition was applied to a base layer, namely, a 125 μm-thick double-sided readily-bondable (anchor-coated) white biaxially stretched polyethylene terephthalate film (LUMIRROR E28G manufactured by Toray Industries, Inc.). The textured sheet capable of providing a surface gloss of 13% obtained in Reference Example 1 was applied thereon, and the resulting laminate was pressed at a pressure of 0.3 MPa and irradiated with ultraviolet rays (irradiation conditions: 1700 mJ/cm²). The embossed sheet was then peeled off, thereby producing a screen (ES1) in which a 10 μm-thick coating (resin layer) was formed on the white biaxially stretched polyethylene terephthalate film. The evaluation results regarding the thus-obtained screen (ES1) are shown in Table 1.

### Examples 2, 3, and 5 to 9 and Comparative Examples 4 to 6

Resin compositions were prepared in the same manner as in Example 1 and screens (ES2), (ES3), (ES5) to (ES9), and (CS4) to (CS6) were produced in the same manner as in Example 1, except that 100 parts by weight of ultraviolet curable resins shown in Table 1, 1 part by weight of the solventless reactive silicone, and the embossed sheets obtained in Reference Example 1 and capable of providing the respective surface glosses shown in Table 1 were used. The evaluation results regarding the thus-obtained screens are shown in Table 1.

### Example 4 and Comparative Example 7

Screens (ES4) and (CS7) were produced in the same manner as in Example 1, except that 100 parts by weight of ultraviolet curable resins shown in Table 1 and the embossed sheets obtained in Reference Example 1 and capable of providing the respective surface glosses were used and the solventless reactive silicone was not used. The evaluation results regarding the thus-obtained screens are shown in Table 1.

### Comparative Example 1

A commercially available screen (PWF-500 manufactured by 3M Japan Limited) (CS1) was used, and a surface thereof on which a resin layer was disposed (i.e., projection surface) was evaluated in the same manner as the screen (ES1) of Example 1. The evaluation results regarding the screen (CS1) are shown in Table 1.

### Comparative Example 2

A commercially available screen (TW-1000 manufactured by Sangetsu Corporation) (CS2) was used, and a surface thereof on which a resin layer was disposed (i.e., projection surface) was evaluated in the same manner as the screen (ES1) of Example 1. The evaluation results regarding the screen (CS2) are shown in Table 1.

### Comparative Example 3

A commercially available screen (KAKIUTSU sheet manufactured by General Co., Ltd.) (CS3) was used, and a surface thereof on which a resin layer was disposed (i.e., projection surface) was evaluated in the same manner as the screen (ES1) of Example 1. The evaluation results regarding the screen (CS3) are shown in Table 1.

TABLE 1

| | Example 1 | Example 2 | Example 3 | Example 4 | Example 5 | Example 6 | Example 7 | Example 8 | Example 9 |
|---|---|---|---|---|---|---|---|---|---|
| Produced | ES1 | ES2 | ES3 | ES4 | ES5 | ES6 | ES7 | ES8 | ES9 |
| Screen | | | | | | | | | |
| Name | | | | | | | | | |
| Material of | White PET | White PET | White PET | White PET | White PET | White PET | White PET | White PET | White PET |
| Base Layer | Film | Film | Film | Film | Film | Film | Film | Film | Film |
| | (E28G)¹⁾ | (E28G)¹⁾ | (E28G)¹⁾ | (E28G)¹⁾ | (E28G)¹⁾ | (E28G)¹⁾ | (E28G)¹⁾ | (E28G)¹⁾ | (E28G)¹⁾ |
| Ultraviolet | NR-G4²⁾ | GY-2³⁾ | GYO-111A⁴⁾ | PET-061⁵⁾ | Z7017⁶⁾ | DRP-075⁷⁾ | PET-061⁵⁾ | Z7017⁸⁾ | PET-061⁵⁾ |
| Curable | | | | | | | | | |
| Resin | | | | | | | | | |
| Silicone | Solventless | Solventless | Solventless | None | Solventless | Solventless | Solventless | Solventless | Solventless |
| | Reactive | Reactive | Reactive | | Reactive | Reactive | Reactive | Reactive | Reactive |
| Surface | 13 | 13 | 13 | 15 | 6 | 6 | 6 | 2 | 2 |
| Gloss (%) | | | | | | | | | |
| Surface | F | 2H | 2B | B | 4H | H | B | 4H | B |
| Pencil | | | | | | | | | |
| Hardness | | | | | | | | | |
| Hot Spot | 4 | 4 | 4 | 4 | 5 | 5 | 5 | 5 | 5 |
| Glare | 4 | 4 | 4 | 4 | 5 | 5 | 5 | 5 | 5 |
| Erasability | 5 | 5 | 5 | 3 | 4 | 4 | 4 | 3 | 3 |
| Scratch | 5 | 5 | 4 | 3 | 5 | 5 | 4 | 3 | 3 |
| Resistance | | | | | | | | | |
| Crack | 2 mm | 6 mm | 2 mm | 2 mm | 6 mm | 4 mm | 2 mm | 6 mm | 2 mm |
| Resistance | or less | | or less | or less | | | or less | | or less |
| | | | Comparative | Comparative | Comparative | Comparative | Comparative | Comparative | Comparative |
| | | | Example 1 | Example 2 | Example 3 | Example 4 | Example 5 | Example 6 | Example 7 |
| | | Produced | CS1 | CS2 | CS3 | CS4 | CS5 | CS6 | CS7 |
| | | Screen | | | | | | | |
| | | Name | | | | | | | |
| | | Material of | Unknown | Unknown | Unknown | White PET | White PET | White PET | White PET |
| | | Base Layer | because of | because of | because of | Film | Film | Film | Film |
| | | | Commercial | Commercial | Commercial | (E28G)¹⁾ | (E28G)¹⁾ | (E28G)¹⁾ | (E28G)¹⁾ |
| | | Ultraviolet | Product | Product | Product | KZ9886³⁾ | NR-G4²⁾ | DRP-075⁷⁾ | KZ7793⁹⁾ |
| | | Curable | | | | | | | |
| | | Resin | | | | | | | |
| | | Silicone | | | | Solventless | Solventless | Solventless | None |
| | | | | | | Reactive | Reactive | Reactive | |
| | | Surface | 21 | 11 | 35 | 45 | 60 | 0.5 | 6 |
| | | Gloss (%) | | | | | | | |
| | | Surface | 2B | 6B | HB | 4B | F | H | 6H |
| | | Pencil | | | | | | | |
| | | Hardness | | | | | | | |
| | | Hot Spot | 4 | 4 | 4 | 2 | 1 | 5 | 5 |
| | | Glare | 2-3¹⁰⁾ | 2-3¹⁰⁾ | 2 | 2 | 1 | 5 | 5 |
| | | Erasability | 5 | 5 | 3 | 4 | 5 | 1 | 1 |
| | | Scratch | 4 | 2 | 3 | 2 | 5 | 1 | 1 |
| | | Resistance | | | | | | | |
| | | Crack | 2 mm | 2 mm | 2 mm | 2 mm | 2 mm | 4 mm | 10 mm |
| | | Resistance | or less | or less | or less | or less | or less | | |

¹⁾White Biaxially Stretched Polyethylene Terephthalate Film (LUMIRROR E28G manufactured by Toray Industries, Inc.)
²⁾Ultraviolet Curable Resin (SEIKABEAM NR-G4 manufactured by Dainichiselka Color & Chemicals Mfg. Co., Ltd.)
³⁾Ultraviolet Curable Resin (GY-2 manufactured by Kyoeisha Chemical Co., Ltd.)
⁴⁾Ultraviolet Curable Resin (GYO-111A manufactured by Nippon Kayaku Co., Ltd)
⁵⁾Ultraviolet Curable Resin (PET-061 manufactured by Nippon Kayaku Co., Ltd)
⁶⁾Ultraviolet Curable Resin (De Solite Z7017 manufactured by JSR Corporation)
⁷⁾Ultraviolet Curable Resin (DPR-075 manufactured by Nippon Kayaku Co., Ltd)
⁸⁾Ultraviolet Curable Resin (De Solite KZ9886F maufactured by JSR Corporation)
⁹⁾Ultraviolet Curable Resin (De Solite KZ7793 maufactured by JSR Corporation)
¹⁰⁾This is because the opinions of each panelist antagonized between 3 and 2.

As can be seen from Table 1, the screens (ES1) to (ES9) obtained in Examples 1 to 9 were all equivalent or superior to the screens (CS1) to (CS7) of Comparative Examples 1 to 7 in almost all the evaluation items for the screens. These results demonstrate the overall superiority of the screens (ES1) to (ES9) as a writable screen.

### INDUSTRIAL APPLICABILITY

The present invention is useful in the field of office equipment manufacturing and the like, for example.

### LIST OF REFERENCE NUMERALS

100 Writable screen
110 Base layer
120 Resin layer
130 Outer surface

1. A writable screen comprising a base layer and a resin layer provided on the base layer,
wherein the resin layer has a surface gloss of 1% to 20% and a surface pencil hardness of 511 to 2B.

2. The writable screen according to claim 1, wherein the surface gloss of the resin layer is 5% to 14%.

3. The writable screen according to claim 1 or 2, wherein the surface pencil hardness of the resin layer is 2H to B.

4. The writable screen according to any one of claims 1 to 3, wherein the resin layer is composed of a cured product of an ultraviolet curable resin with a reactive silicone.

5. The writable screen according to claim 4, wherein the reactive silicone is a polysiloxane modified with an acrylic acid group or a methacrylic acid group.
